(19) United States
(12) Patent Application Publication
(10) Pub. No.: US 2009/0235489 A1
(43) Pub. Date: Sep. 24, 2009

(54) Sheath Type Rotating Axel Structure with Automatic Locking Mechanism

(76) Inventors: Jui-Hung CHANG, Sinjhuang City (TW); Chun-Hung Hu, Sinjhuang City (TW)

Correspondence Address: Guice Patents PLLC, 12647 Galveston Court #302, Manassas, VA, 20112, US

(21) Appl. No.: 12/258,068

(22) Filed: Oct. 24, 2008

(30) Foreign Application Priority Data
Oct. 25, 2007 (TW) 096140002

(51) Int. Cl. E05D 11/08

(52) U.S. Cl. 16/340

(57) ABSTRACT

The present invention discloses a sheath type rotating axle structure with automatic locking mechanism, comprising a sheath device, a retainer, a pivotal axle, a locking fastener, a locking rotator, a resilient body, and a screw nut. The first axle segment of the pivotal axle is pivoted to the sheath of the sheath device to realize the function of “easy opening and firm closing,” and the sheath device is disposed with a retainer on one end to achieve the “anti-shaking” function. The second axle segment of the pivotal axle is pivoted to the through hole of the retainer and embeddingly inserted into a locking fastener and a locking rotator. The locking fastener is disposed with a pin to be securingly fixed with a pin hole formed on the retainer, and a screw nut is used to securingly fix a plurality of resilient discs or a spring. When the pivotal axle is rotated to drive the locking fastener departing from the locked position, the resilient discs (or spring) are compressed by the locking rotator. Also, when the pivotal axle is rotated back to drive the locking rotator returning to the locked position, the resilient discs (or spring) press the locking rotator back to the locked position, so as to achieve the function of “automatic locking.”

### FIELD OF THE INVENTION

The present invention relates to a rotating axle structure, and more particularly to a sheath type rotating axle structure with automatic locking mechanism.

### BACKGROUND OF THE INVENTION

It is common to see two objects being rotated angularly relative to each other for opening or closing; door panel, for example, is seen and used in every household. On the other hand, it is also common to see devices which are flipped open to operate or closed to power off, commonly seen portable computer, electronic dictionary, portable audio/video player, and so on, for example.

A hinge is usually used for such a device for adjusting the relative angle between two objects. In a portable computer, it is usually called rotating axle or pivotal device for such a purpose. Regardless of rotating axle or pivotal device involved, they both make use of torsion or friction. Basically, an engagement assembly, frictional element or cam element, is provided on each of the two objects for flipping open/closed by engaging each other.

“ROTATING SHAFT STRUCTURE WITH AUTOMATIC LOCKING MECHANISM” as shown in FIG. 1, is invented by the applicant and disclosed in the ROC Patent M296586 on Aug. 21, 2006 (equivalent to that disclosed in China Patent 200620001995.4). In the patent, the shaft 11 of the axial member 10 is inserted into, in the order of, a friction disc 30, a connecting plate 40, a cam member 50, and an elastic body 60, and then they are securingly fixed on the main frame 20, wherein the cam member 50 comprises a fastening part 501 and the sliding part 502. When the axial member 10 is rotated, the wedge slots 502a of the sliding part 502, under the force exerted by the elastic body 60, are engaged into the wedge block 501a of the fastening part 501 to achieve automatic locking.

Although the conventional art described above can achieve the automatic locking function, to realize the further improved functions of “easy opening and firm closing” and “anti-shaking,” some improvements over the rotating axle structure have to be made.

### SUMMARY OF THE INVENTION

In view of the foregoing shortcomings of the prior art, the inventor of the present invention based on years of experience in the related industry conducts extensive researches and experiments with an attempt to overcome the drawback of “firm opening and easy closing” for conventional rotating axle with anti-shaking mechanism, and finally invented a sheath type rotating axle structure with automatic locking mechanism as well as improvements in “easy opening and firm closing” and “anti-shaking” in accordance with the present invention.

The objective and the improved function are characterized in providing rotating axle with the functions of “automatic locking,” “easy opening and firm closing,” and “anti-shaking.”

To achieve the objectives described above, one technical approach adopted in the present invention is primarily to provide a sheath type rotating axle structure, comprising a sheath device disposed with a sheath on one end and a protruding block on the other; a retainer disposed with a through hole and a groove which can be securingly fixed with the protruding block; a pivotal axle disposed with a first axle segment which is pivoted to the sheath and a second axle segment which is pivoted to the through hole of the retainer; a locking fastener inserted by the second axle segment of the pivotal and securingly fixed on the retainer; and a locking rotator securingly fixed on the second axle segment of the pivotal axle and abutted against the locking fastener, wherein a plurality of resilient discs is fixed by a screw nut at the end of the second axle segment of the pivotal axle, such that when the pivotal axle is rotated to drive the locking fastener departing from the locked position, the resilient discs are compressed by the locking rotator and when the pivotal axle is rotated back to drive the locking rotator returning to the locked position, the resilient discs press the locking rotator back to the locked position.

The other technical approach adopted in the present invention is primarily to provide a sheath type rotating axle structure, comprising a sheath device disposed with a sheath and provided with a retainer on one side; a pivotal axle disposed with a first axle segment which is pivoted to the sheath and a second axle segment which is pivoted to the through hole of the retainer and inserted by in the order of a locking fastener and a locking rotator, and a spring is capped at the end of the second axle segment by a screw nut, wherein the locking fastener is securingly fixed on the retainer, the locking rotator may be rotated integratedly with the second axle segment of the pivotal axle, such that when the pivotal axle is rotated to drive the locking fastener departing from the locked position, the resilient discs are compressed by the locking rotator and when the pivotal axle is rotated back to drive the locking rotator returning to the locked position, the resilient discs press the locking rotator back to the locked position.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 is an exploded perspective view of a conventional rotating axle structure with automatic locking mechanism;

FIG. 2 is an exploded perspective view of a rotating axle structure with automatic locking mechanism in accordance with the present invention;

FIG. 3 is an exploded perspective view of a rotating axle structure with automatic locking mechanism along a different view angle in accordance with the present invention;

FIG. 4 is an assembled perspective view of the present invention;

FIG. 5 is a cross-sectional view taken from the A-A line in FIG. 4; and

FIG. 6 is a drawing of partial enlargement of the cross-sectional view in FIG. 5.

FIG. 7 is a perspective view of a locking fastener and a locking rotator of the present invention; and

FIG. 8 is an assembled perspective view of a rotating axle of the present invention connected with a support frame and a fixed base.

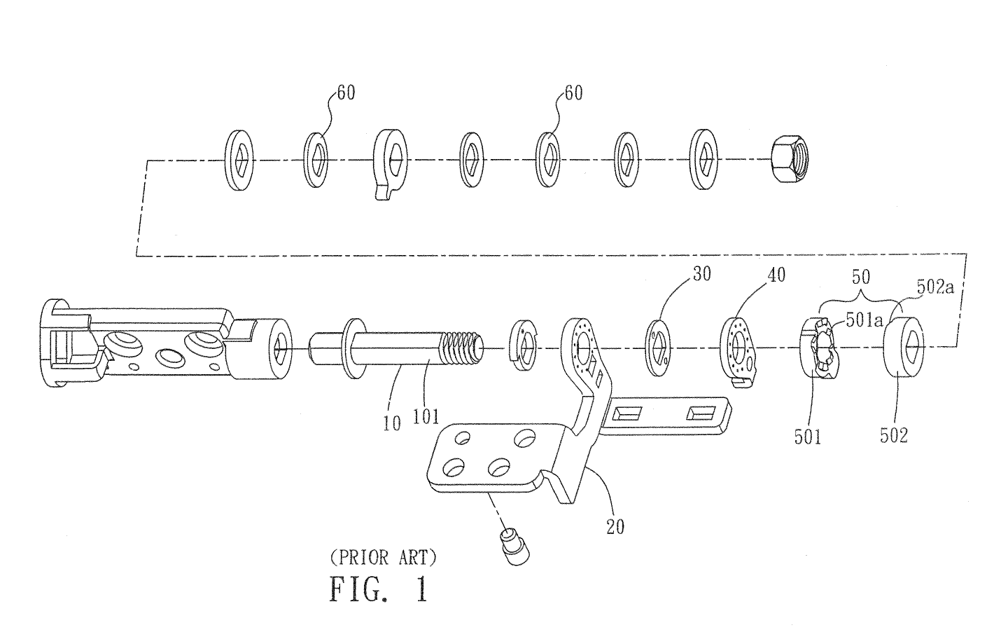

### DETAILED DESCRIPTION OF THE PREFERRED EMBODIMENTS

The structure, technical measures and effects of the present invention will now be described in more detail hereinafter with reference to the accompanying drawings that show various embodiments of the invention.

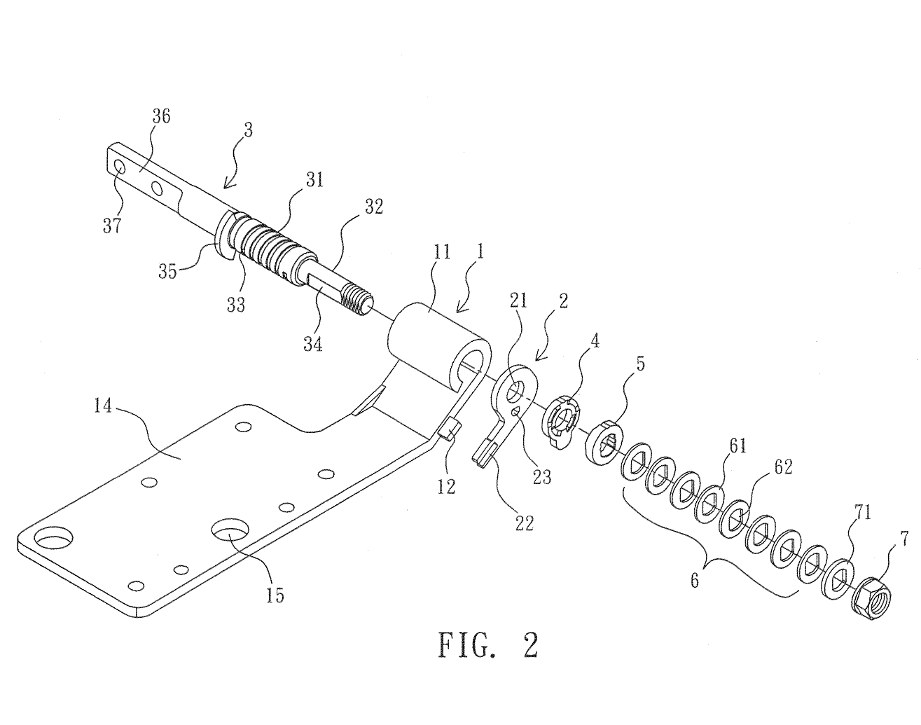

With reference to FIGS. 2 to 4, a sheath type rotating structure with automatic locking mechanism in accordance with the present invention comprises a sheath device 1, a retainer 2, a pivotal axle 3, a locking fastener 4, a locking rotator 5, a resilient part 6, and a screw nut 7, wherein the sheath device 1 and the pivotal axle 3 are further connected with a support frame 8 and a fixed base 9, respectively.

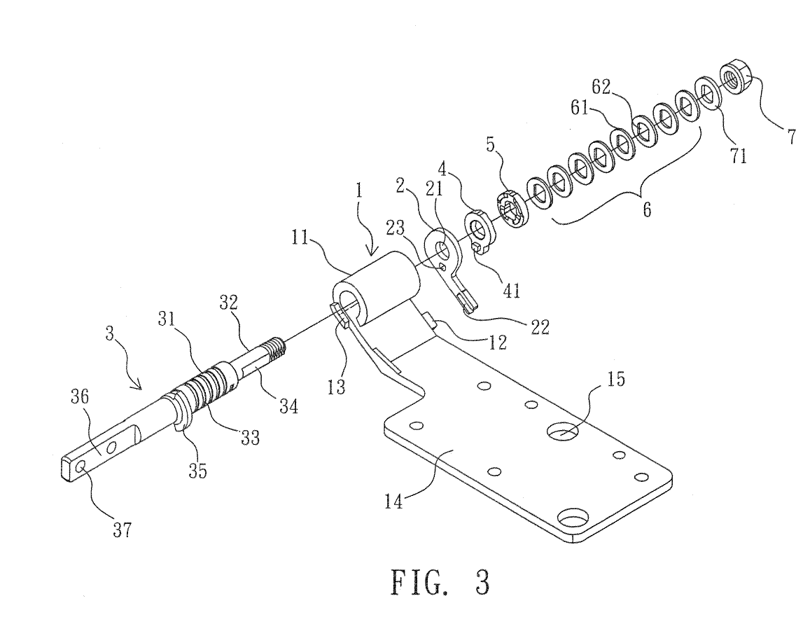

The sheath device 1 is a frame, whose one end is a sheath 11 and the other end is protrudingly disposed with a protruding block 12 for the insertion and locating of the retainer 2. As shown in FIG. 3, one side of the sheath device 1 is protrudingly disposed with a stopping portion 13 to restrict the rotation angle of the pivotal axle 3.

The retainer 2 is a plate disposed with a through hole 21 for the insertion of the second axle segment 32 of the pivotal axle to prevent the pivotal axle 3 from shaking upon rotating. To enable the retainer 2 fixed on one side of the sheath 11, the retained 2 is formed to have a groove 22 corresponding to the protruding block 12 and is secured by embeddingly inserting the protruding block 12 into the groove 22 for fixing.

The pivotal axle 3 is s stepped rod with a first axle segment 31 and a second axle segment 32, as shown in FIGS. 2 and 3. The outer diameter of the first axle segment 31 is larger than that of the second axle segment 32, and the first axle segment 31 is pivoted to the sheath 11 of the sheath device 1 so as to achieve the function of “easy opening and firm closing.” Also, the second axle segment 32 is inserted into the through hole 21 of the retainer 2 so as to prevent the pivotal axle 3 from shaking. To provide the lubrication between the first axle segment 31 and the sheath 11, the first axle segment 31 is formed on its surface to have oil groove 33, a helical oil groove for example. Furthermore, the second axle segment 32 is at least formed to have a flat surface 34, which is inserted into the through hole 21 and is further inserted into a locking fastener 4, a locking rotator 5, and a the resilient body 6. Then, the screw segment of the second axle segment 32 is capped with a screw nut 7, such that the lateral elastic force exerted by the resilient body 6 drives the locking rotator 5 to be connected together with the adjacent locking fastener 4. Furthermore, the first axle segment 31 of the pivotal axle 3 is formed to have a locating portion 35; thus, when the pivotal axle 3 is rotated, the locating portion 35 of the pivotal axle 3 is abutted against the stopping portion 13 of the sheath device 1 so as to restrict the rotation angle of the pivotal axle 3.

With reference to FIGS. 2 and 3, the resilient body 6 comprises a plurality of resilient discs 61, which have a curved face and are alternately stacked of different faces and inserted by the second axle segment 32. However, the resilient body 6 is not limited to the resilient discs 61; it can be a spring. The resilient discs 61 are moved integratedly with the second axle segment 32 of the pivotal axle 3, and therefore the fastening hole 62 formed at the resilient disc 61 has to be compatible with the cross-section of the second axle segment 32 with at least one flat face 34. Also, a spacer 71 is disposed between the resilient body 6 and screw nut 7 so as to prevent the screw nut 7 from coming off.

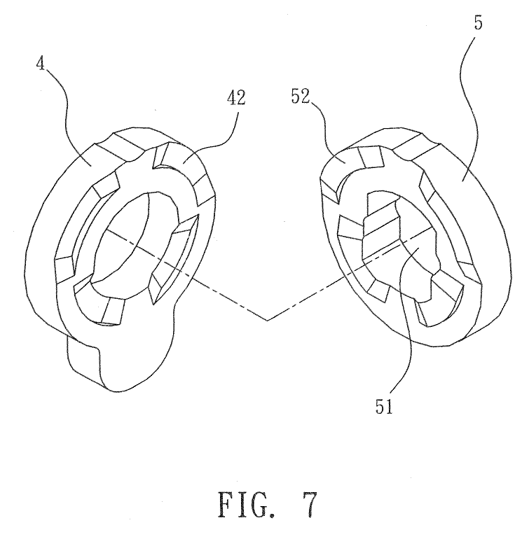

With reference to FIGS. 2, 3, and 7, the locking fastener 4 is formed to have a round hole for insertion of the second axle segment 32, which is secured on one side of the retainer 2. With reference to FIG. 3, the locking fastener 4 is disposed with a pin 41, which is inserted into a pin hole 23 of the retainer 2, such that the locking fastener 4 is securingly fixed on one side of the retainer 2. Furthermore, the secured fixing between the locking fastener 4 and the retainer 2 can also be realized by that the locking fastener 4 is formed to have a pin hole and the retainer 2 is correspondingly provided with a pin. The locking rotator 5 is formed to have a fastening hole 51 which is compatible to the cross section of the second axle segment 32 so as to move integratedly together. With reference to FIG. 7, the locking fastener 4 is formed to have a locating slot 42 and the locking rotator 5 is disposed with a locating block 52. At the locked position, the locating block 52 is positioned in the locating slot 42. Moreover, the embodiment can also be carried out by disposing a locating block on the locking fastener 4 and the locking rotator 5 is formed to have a locating slot.

Consequently, when the pivotal axle 3 is rotated to drive the locking rotator 5 departing from the locked position, the resilient discs 61 (or spring) are compressed by the locking rotator 5. Also, when the pivotal axle 3 is rotated back to drive the locking rotator 5 returning to the locked position, the resilient discs 61 (or spring) press the locking rotator 5 back to the locked position, so as to achieve the function of “automatic locking.”

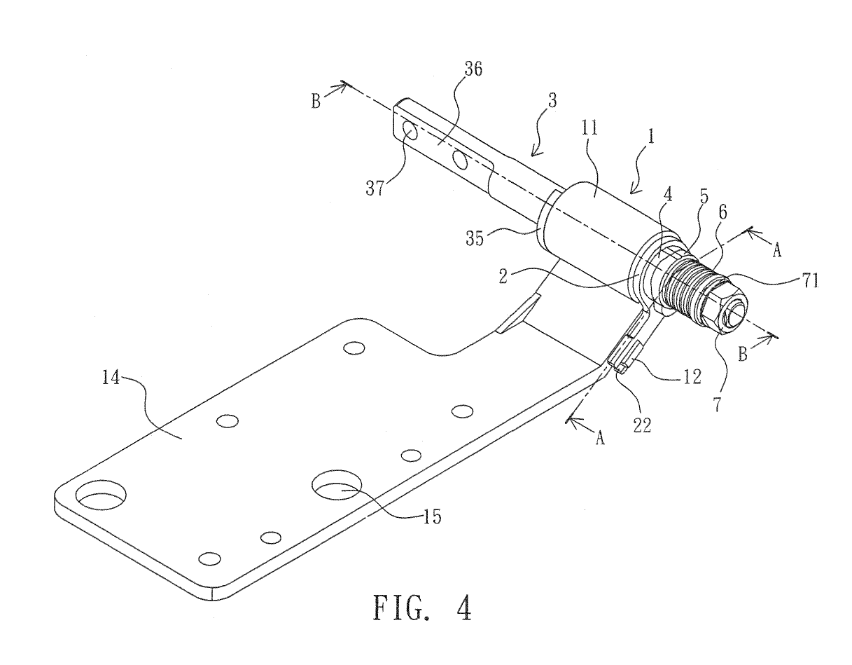

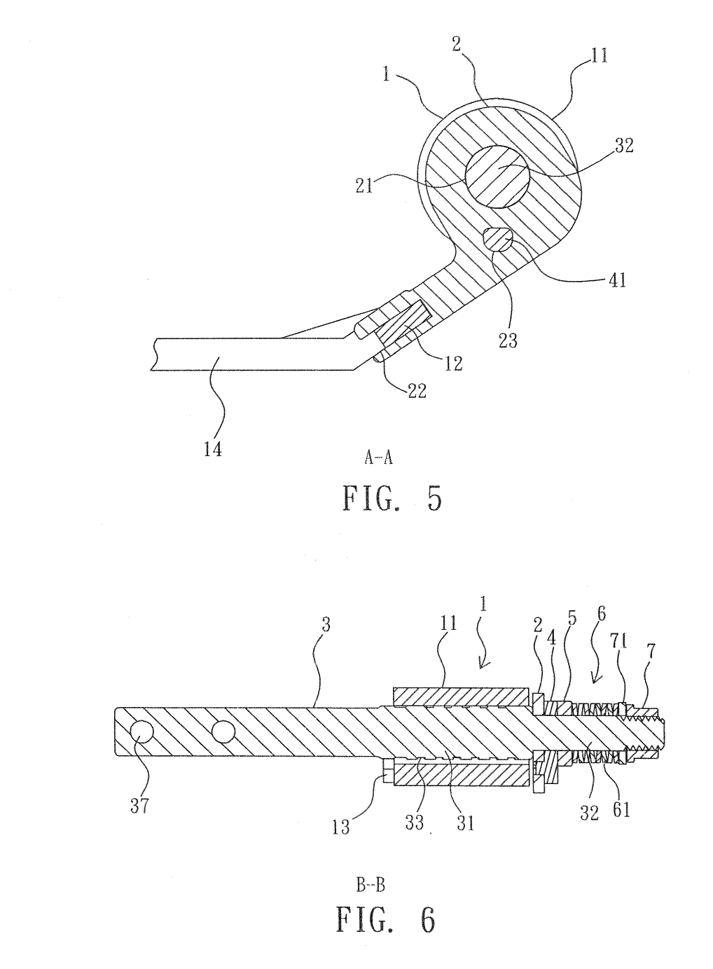

The present invention is assembled according to the above descriptions and the perspective view in accordance with the present invention is shown in FIG. 4. FIG. 5 is a cross-sectional view taken along the A-A line, in which the sheath device 1 and the retainer 2 are embeddingly connected by the protruding block 12 and the groove 22 to be securingly fixed. Furthermore, FIG. 6 is a cross-sectional view taken along the B-B line, in which the relative arrangement of the components involved in the present invention are shown; for example, the first axle segment 31 of the pivotal axle 3 is pivoted to the sheath 11 of the sheath device 1; the second axle segment 32 is pivoted to the through hole 21 of the retainer 2 and is then inserted into in the order of a locking fastener 4, a locking rotator 5, a resilient body 6, and a screw nut 7; and the locking fastener 4 is fixed by embeddingly inserting the pin 41 into the pin hole 23 of the retainer 2.

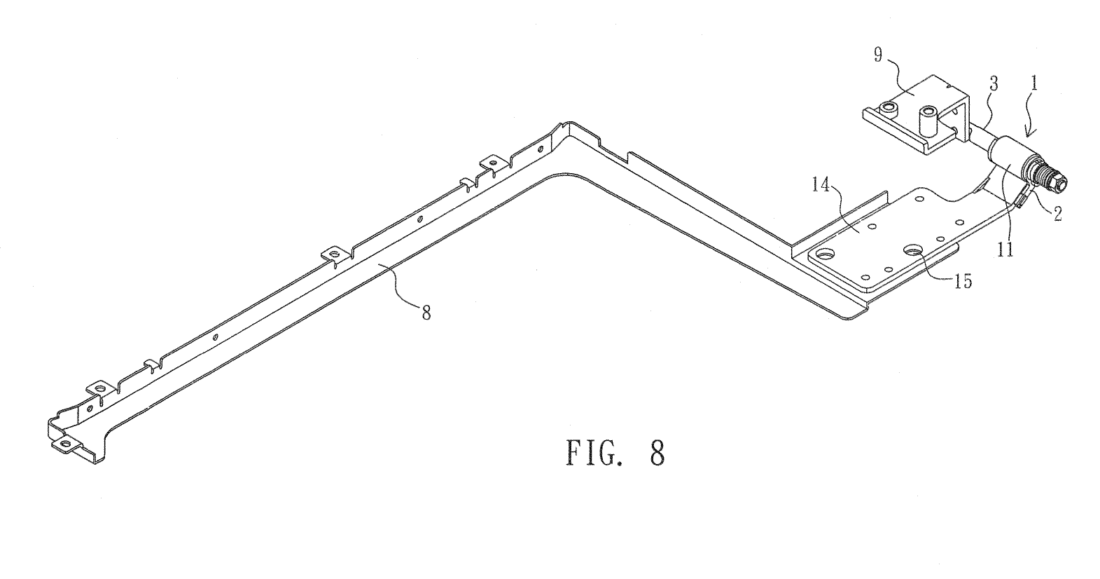

With reference to FIG. 8, to enable the sheath device 1 and the pivotal axle 3 of the present invention connected with an object, the cover body and the main body of a notebook computer for example, the sheath device 1 is extended to form an extended end 14 whose surface is formed to have a plurality of locating holes 15 and thus securingly connected with the support frame 8 of a cover body. The other end of the pivotal axle 3 is disposed with a connection end 36 which is formed to have a plurality of connection holes 37, so as to be connected with a fixed base 9 of a main body.

Consequently, with the implementation of the present invention, the first axle segment of the pivotal axle is pivoted to the sheath of the sheath device to realize the function of “easy opening and firm closing,” and the sheath device is disposed with a retainer on one end to achieve the “anti-shaking function.” The second axle segment of the pivotal axle is pivoted to the through hole of the retainer and embeddingly inserted into a locking fastener and a locking rotator. The locking fastener is disposed with a pin to be securingly fixed with a pin hole formed on the retainer, and a screw nut is used to securingly fix a plurality of resilient discs or a spring. When the pivotal axle is rotated to drive the locking fastener departing from the locked position, the resilient discs (or spring) are compressed by the locking rotator. Also, when the pivotal axle is rotated back to drive the locking rotator returning to the locked position, the resilient discs (or spring) press the locking rotator back to the locked position, so as to achieve the function of “automatic locking,” which is indeed a novelty not seen before in the prior art.

The present invention provides a feasible solution, and a patent application is duly filed accordingly. However, it is to be noted that the preferred embodiments disclosed in the specification and the accompanying drawings are not intended to limit the invention. To the contrary, it is intended to cover various modifications and similar arrangements and procedures, and thus the scope of the appended claims should be accorded the broadest interpretation so as to encompass all such modifications and similar arrangements and procedures.

What is claimed is:

1. A sheath type rotating axle structure with automatic locking mechanism, comprising:
a sheath device disposed with a sheath on one end and a protruding block on the other;
a retainer disposed with a through hole and a groove which can be securingly fixed with the protruding block;
a pivotal axle disposed with a first axle segment which is pivoted to the sheath and a second axle segment which is pivoted to the through hole of the retainer;
a locking fastener inserted by the second axle segment of the pivotal and securingly fixed on the retainer; and
a locking rotator securingly fixed on the second axle segment of the pivotal axle and abutted against the locking fastener, in which a plurality of resilient discs is fixed by a screw nut at the end of the second axle segment of the pivotal axle;
such that when the pivotal axle is rotated to drive the locking fastener departing from the locked position, the resilient discs are compressed by the locking rotator and when the pivotal axle is rotated back to drive the locking rotator returning to the locked position, the resilient discs press the locking rotator back to the locked position.

2. The sheath type rotating axle structure with automatic locking mechanism as defined in claim 1, wherein the locking fastener is formed to have a locating slot and the locking fastener is disposed with a locating block, and at the locked position, the locating block is positioned in the locating slot.

3. The sheath type rotating axle structure with automatic locking mechanism as defined in claim 1, wherein the locking fastener is disposed with a locating block and the locking fastener is formed to have a locating slot, and at the locked position, the locating block is positioned in the locating slot.

4. The sheath type rotating axle structure with automatic locking mechanism as defined in claim 1, wherein the other side of the sheath device is disposed with a stopping portion and the first axle segment of the pivotal axle is disposed with a locating portion, and when the pivotal axle is rotated, the locating portion of the pivotal axle is abutted against the stopping portion of the sheath device so as to restrict the rotation angle of the pivotal axle.

5. The sheath type rotating axle structure with automatic locking mechanism as defined in claim 1, wherein the locking fastener is disposed with a pin and the retainer is correspondingly formed to have a pin hole, such that the locking fastener may be securingly fixed with the retainer.

6. The sheath type rotating axle structure with automatic locking mechanism as defined in claim 1, wherein the locking fastener is formed to have a pin hole and the retainer is correspondingly disposed with a pin, such that the locking fastener may be securingly fixed with the retainer.

7. The sheath type rotating axle structure with automatic locking mechanism as defined in claim 1, wherein the first axle segment of the pivotal axle is formed on its surface to have an oil groove and a spacer is disposed between the screw nut and the plurality of resilient discs.

8. The sheath type rotating axle structure with automatic locking mechanism as defined in claim 1, wherein the second axle segment is at least formed to have a flat surface and the locking rotator and the plurality of resilient discs are correspondingly formed to have fastening holes for the insertion of the second axle segment.

9. The sheath type rotating axle structure with automatic locking mechanism as defined in claim 1, wherein the plurality of resilient discs have a curved face, and are alternately stacked of different faces and inserted by the end of the second axle.

10. The sheath type rotating axle structure with automatic locking mechanism as defined in claim 1, wherein the sheath device is extended to form an extended end whose surface is formed to have a plurality of locating holes to be securingly connected with the support frame, and the pivotal axle is disposed with a connection end which is formed to have a plurality of connection holes to be connected with a fixed base.

11. A sheath type rotating axle structure with automatic locking mechanism, comprising
a sheath device disposed with a sheath and provided with a retainer on one side;
a pivotal axle disposed with a first axle segment which is pivoted to the sheath and a second axle segment which is pivoted to the through hole of the retainer and inserted by in the order of a locking fastener and a locking rotator, and
a spring is capped at the end of the second axle segment by a screw nut, in which the locking fastener is securingly fixed on the retainer, the locking rotator may be rotated integratedly with the second axle segment of the pivotal axle;
such that when the pivotal axle is rotated to drive the locking fastener departing from the locked position, the resilient discs are compressed by the locking rotator and when the pivotal axle is rotated back to drive the locking rotator returning to the locked position, the resilient discs press the locking rotator back to the locked position.

12. The sheath type rotating axle structure with automatic locking mechanism as defined in claim 11, wherein the locking fastener is formed to have a locating slot and the locking fastener is disposed with a locating block, and at the locked position, the locating block is positioned in the locating slot.

13. The sheath type rotating axle structure with automatic locking mechanism as defined in claim 11, wherein the other side of the sheath device is disposed with a stopping portion and the first axle segment of the pivotal axle is disposed with a locating portion, and when the pivotal axle is rotated, the locating portion of the pivotal axle is abutted against the stopping portion of the sheath device so as to restrict the rotation angle of the pivotal axle.

14. The sheath type rotating axle structure with automatic locking mechanism as defined in claim 11, wherein the locking fastener is disposed with a pin and the retainer is correspondingly formed to have a pin hole, such that the locking fastener may be securingly fixed with the retainer.

15. The sheath type rotating axle structure with automatic locking mechanism as defined in claim 11, wherein the first axle segment of the pivotal axle is formed on its surface to have an oil groove and a spacer is disposed between the screw nut and the plurality of resilient discs.

16. The sheath type rotating axle structure with automatic locking mechanism as defined in claim 16, wherein the sheath device is extended to form an extended end whose surface is formed to have a plurality of locating holes to be securingly connected with the support frame, and the pivotal axle is disposed with a connection end which is formed to have a plurality of connection holes to be connected with a fixed base.
